(19) United States
(12) Patent Application Publication
(10) Pub. No.: US 2012/0141267 A1
(43) Pub. Date: Jun. 7, 2012

(54) Wind turbine blade automatic pitch control using centrifugal force

(76) Inventor: Michael Ching Kwei Kang, Spring, TX (US)

(21) Appl. No.: 12/906,100

(22) Filed: Dec. 3, 2010

(51) Int. Cl. F03D 7/00

(52) U.S. Cl. 416/1; 416/117

(57) ABSTRACT

A method and related apparatus to control pitch angle of the blade of any horizontal axis wind turbines (wind generators or wind mills), which employs only the centrifugal force of the blade assembly including the blades and the moving parts of the patented apparatus.

The pitch control is automatic when the rotational speed of the turbine rotor reaches certain pre-set value, the blade pitch angle is increased by the centrifugal forces of the blade assembly, thus the apparatus restricts the maximum rotating speed of the turbine rotor, and protects the wind turbine from being destructed by excessive wind speed, yet the wind turbine will keep running and producing power at the excessive wind speed.

Due to the simplicity and low cost, this method and related apparatus are more suitable for medium and small wind generators (e.g., power <10 KW), where the conventional hydraulic or electrical power-actuated pitch control apparatuses are too complicate and too costly to be installed.

### BACKGROUND OF THE INVENTION

The present invention includes a method and related apparatuses to control wind turbine-blade pitch.

### A. General Information

To control the rotational speed and to protect a wind turbine from over-speed destruction, the method of blade pitch angle control is widely used: the pitch angle can often be adjusted from 0 degree (at base-rpm) to a maximum of 90 degrees or so (pass the full-feathered position to reverse thrust/torque of the turbine rotor). However, previous methods often use electrical or hydraulic powered mechanisms to adjust the blade pitch, those designs required extra power sources, are usually complex, heavy, and expensive. Therefore they are suitable only for larger wind turbines (e.g., turbine power >10 KW).

For medium and small (turbine power <=10 KW) wind turbines, the blade pitch are often fixed. Some other means have been designed for blade pitch and rotor speed control, including: yawing the turbine axis off the wind direction, and some weight additions to the blade, using their centrifugal force to control the pitch, etc., some designs worked but often they are different from the current design and they may not be simple. Thus a simple, low cost, non-powered design has been desired for a long time.

### B. Current Design

a. The current invention is a special method using the weight and centrifugal force of each blade assembly to control the blade pitch and thus the turbine rotor speed in high wind. (The additional weight and centrifugal force of the attached moving parts of the apparatus may be small relative to the blade but are also helping the pitch control means). This method and apparatus can be installed to each blade of any horizontal axis wind turbine. Although it also increases the mass and moment of inertia of the blade assembly, the increased inertia are compensated by the increased rotor-diameter at the same time, thus caused minimum changes in starting and running performance but increases the power generated by the wind turbine. (Some slight adjustments of the 0 degree base-rpm pitch angle setting may be needed for a particular wind turbine design).
b. The centrifugal force induced automatic pitch control method/apparatus, with an axially moving helical spline shaft (spool) or a cylindrical cam shaft inside a cylindrical housing, to constrict the axial movement with the rotation of the shaft. The centrifugal force is generated when the wind turbine rotates, due to the weight of the turbine blade assembly. The axial movements of the shaft in both directions are thus associated with the rotations of the shaft via the helical spline or the cylindrical cam mechanism. The shaft-end may be mounted to the turbine blade or to the turbine hub depending on the actual design of the wind turbine. Therefore, the rotation of the shaft or the housing will result into the change of the pitch angle of the blade attached to the shaft end or the housing end of the apparatus.
c. A cylindrical housing for the above spline shaft, the housing is mounted on the root of each blade or the hub of a wind turbine, depending on the actual design of the wind turbine. Inside of the housing has a fixed internal annular sleeve (or cam-follower) matching the helical spline teeth (or the cylindrical cam) on the shaft, which causes the shaft to rotate when moving axially, in order to change the pitch angle of the attached blade.
d. A coil spring is inside the housing and surrounding the shaft. The spring is pre-loaded by a locknut to balance the weights of the blade assembly, and their centrifugal forces under the designed nominal rotating speed (base-rpm) of the wind turbine rotor. The spring can also be a torsional spring to pre-load the shaft against the rotation of the shaft with respect to the housing.
e. Apparatuses with internal cylindrical cam shaft/housing-follower arrangement to replace the helical sliding spline shaft/housing-sleeve arrangement, the cylindrical cam can be slots carved on the shaft, and the follower can be rollers fixed inside the housing cylinder, or any other cylindrical cam design which perform the same inter-meshed axial-rotational movement of the shaft inside the cylindrical housing. All other structural principle and operating method (automatic pitch control by using centrifugal force of the blade assembly) are the same as in a.
f. Pitch control is actuated automatically when the turbine rotates faster than the base-rpm, the added centrifugal forces of the blade assembly will cause the blade to move axially, which will increase the blade pitch angel due to the spline or cam induced rotation of the spline shaft/housing. The maximum pitch angle allowed by the apparatus is 90 degrees from the base-setting of zero degree. Therefore for the wind turbines, the blade pitch can pass the zero-torque full feathered angle if it reaches 90 degrees, which will actually produces negative-torque to slow down the turbine rotating speed. Therefore, the rotating speed of the turbine rotor is automatically limited to a maximum value.
g. For a horizontal axis wind turbine, when a blade is at the lowest position on the wind turbine (i.e., blade tip is pointing to the ground), the weight of the blade assembly Wt actually works against the spring force. Therefore, at the lowest position, the blade extension and pitch angle are maximum in each turbine rotor rotation. This has an added advantage that the increased rotor circle diameter due to the extended blade actually produces more torque, which will automatically compensate the torque losses due to the tower interference and lower wind speed near the ground. Conversely, when the blade is at the highest position (i.e., blade tip is pointing to the sky), the centrifugal forces Fc are working against the spring force and the weight of the blade assembly Wt, therefore, the extension and pitch angle of the blade are minimum at the same rotation speed. However, the higher wind speed at higher blade position will produce more torque to compensate the slightly shorter blade extension. Therefore smooth rotation of the whole wind turbine rotor is maintained.
h. Since the blade axis is usually chosen along the aerodynamic centers (often at quarter chord) of the blade airfoil sections, twisting moment generated by the wind on airfoil sections about the blade axis is usually zero or negligible. However, in case of strong wind, some blade airfoils can generate twisting moment about its axis; this apparatus allows such moment to slightly increase the pitch angle of the blades and thus reduce the turbine speed, which is another advantage of the invented method. Nevertheless, the pitch angle of the blade is controlled mainly by the centrifugal force Fc and weight of the blade assembly Wt, and the pre-set spring force in the apparatus.

### SUMMARY OF THE INVENTION

### A. Brief Description of the Drawings

These features and advantages of the present invention are described in connection with the accompanying drawings, in which:

FIG. 1 is a schematic perspective view of a wind turbine embodying the present invention; and

FIG. 2 is a schematic diagram of the apparatus with helical sliding spline shaft, housing and other components, with the shaft at its left most position, the coil spring is extended, and the blade is at its base angle of attack. This is a typical design of the present invention.

FIG. 3 is a schematic diagram of the apparatus with helical sliding spline shaft, housing and other components, with the shaft at its right most position, the coil spring is compressed, and the blade is at its maximum angle of attack.

### B. BRIEF DESCRIPTION OF THE INVENTION

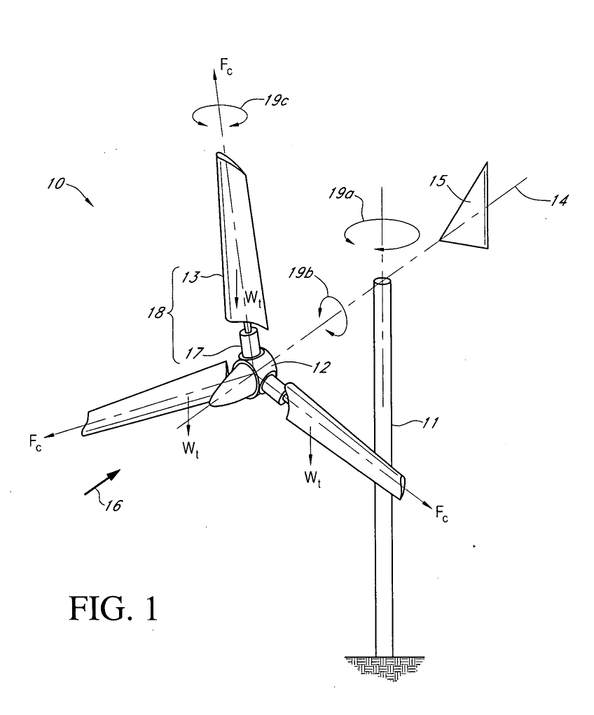

FIG. 1 shows the invented method 30 and related apparatuses 17 are applied to a horizontal axis wind turbine, mounted on a support tower structure 11 so that it can pivot 19a to face into the wind. A turbine rotor assembly 10 is mounted on the chassis (rotor assembly includes a turbine shaft, a hub, and turbine blades extending outward from the hub). The turbine rotor assembly is mounted to rotate 19b with respect to the chassis about the turbine axis, and the turbine rotor assembly is aerodynamically arranged so that it pivots 19a into the wind, i.e., an orientation in which the axis of the turbine shaft is approximately parallel to the wind direction and the front end of the rotor faces into the wind (i.e., at the up-wind side of the tower, this is called push-type rotor. A pull-type rotor is also possible, with the rotor at the down-wind side of the tower). The wind flow creates lift/drag forces on the turbine rotor blades 13, and generates rotational torque to spin the turbine rotor 10 to generate power. The blades can be twisted 19c about their blade axes to change their pitch angles 33 about the blade axes, from the designed 0 degree pitch angle at or below base-rpm of the rotor, to 90 degrees pitch angle at negative torque or negative rpm position, with a full-feathered position in between (where the torque generated about the turbine axis by the blades due to wind flow is substantially zero). Notice that even at 0 degree pitch angle setting, the airfoil sections of the blades are not perpendicular to the wind turbine axis, but at a pre-designed angle of attack for optimal power generation of the wind turbine at base-rpm.

According to the present invention, the wind turbine further includes the invented apparatus mounted at the root of each blade to connect the blade to the hub, either by a shaft-nut attachment or a web-flange attachment, depending on the original wind turbine design, because the apparatus is effective when used either way. As a result, the blade pitch angle is adjustable from 0 degree to 90 degrees from the pitch for base-rpm or below, to the maximum angle by centrifugal force. The power to adjust the pitch is by the excess (less the weight Wt) centrifugal force Fc of the blade assembly when the blade is at highest position, and by the weight plus centrifugal force Fc of the blade assembly when the blade is at the lowest position. Therefore the turbine rotor assembly (including multiple blades, hub, turbine shaft, and the rotor of the power generator) can rotate at designed base-rpm or lower rpm at 0 degree pitch angle, any angle in between, and at the pass full-feathered positions when that pitch angle reaches 90 degrees.

Such an arrangement is beneficial to restrict the turbine rotor speed of any wind turbine to achieve better performance and prevent destruction due to over-speed of the rotor.

### DETAILED DESCRIPTION OF THE INVENTED APPARATUS

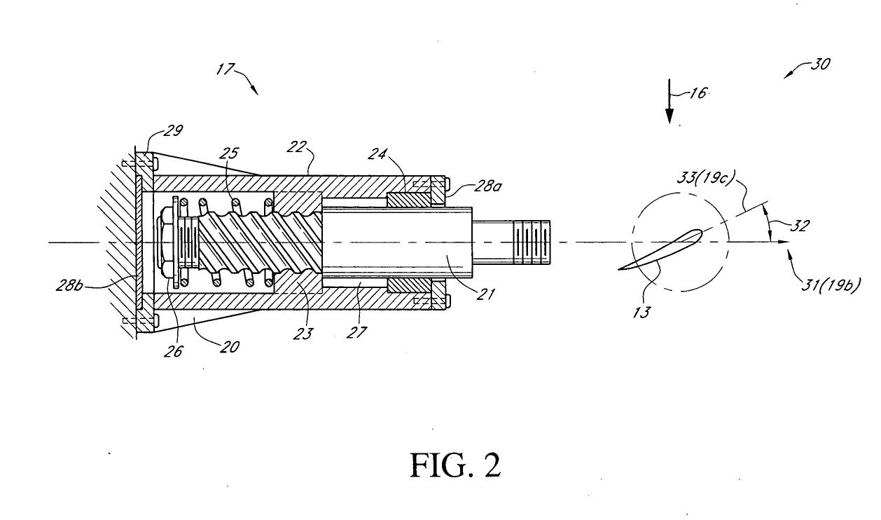

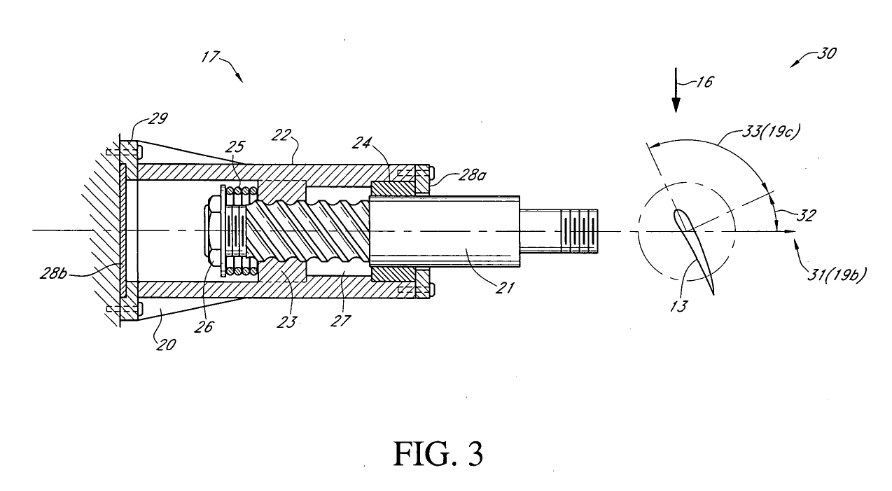

Apparatuses 17 with internal helical sliding spline shaft 21 as shown in FIG. 2 and FIG. 3. There are 6 major components of this design, namely: a shaft 21, a housing 22, an annular spline sleeve 23, a bushing 24, a spring 25, and a locknut 26.

a. The shaft 21 is a solid, high strength steel shaft, its spool section is cut with helical spline (helical angle may be 30 to 45 degrees) to match the housing internal annular spline sleeve 23, and a sliding finish section to match the sliding bushing 24 installed in the housing 22. Both ends of the shaft are standard screw thread to match the attachment of the locknut 25 and standard nuts (not shown).
b. The housing 22 is made of high strength steel cylinder, it has mounted securely an internal annular spline sleeve 23 and a sliding bushing 24 inside, and one retainer/grease cover 28a and one dust/mist cover 28b on the front and back end, respectively. Additional webs 20 and flange 29 can be welded on the cylinder wall of the back end to attach the whole apparatus 17 to the hub 12 or blade 13 of a wind turbine, depending on the wind turbine design.
c. The internal annular spline sleeve 23 has internal thread to match the spline on the shaft 21, which only allows rotation and axial motion of the shaft at the same time, in both directions. The maximum allowed shaft rotation is 90 degrees for the wind turbine application, but can be changed for other applications.
d. The sliding bushing 24 supports the shaft (spool) and allows free rotational and axial motion of the shaft inside the housing 22.
e. The spring 25 may be a coil spring of any kind, which is to pre-load the shaft 21 against the housing-sleeve to work against the weight Wt and centrifugal force Tc at base-rpm of the blade assembly (including the blade, and the moving parts could be the spline shaft and spring/locknut or the housing, depending on which end of the apparatus 17 is attached to the blade 13). The spring 25 can also be a torsional spring to be pre-loaded to work against the rotation and axial movement of the shaft with respect to the housing.
f. The locknut 26 is a special nut to pre-load the spring 25 and hold the spline shaft 21 in the housing-sleeve 22.
g. The grease chamber 27 is partially filled with grease to lubricate the spline and the bushing 24, and protect them from rusting and moisture, thus achieve a maintenance-free environment. The grease can also serve as damping material for the axial ripple vibrations of the blade 13 if happens.

### DETAILED DESCRIPTION OF THE DRAWINGS

FIG. 1 depicts a wind turbine rotor assembly 10 mounted on a tower 11 that supports the wind turbine above the ground. A wind turbine rudder 15 is mounted at the turbine shaft 14 to maintain the orientation by pivoting (19a) the whole turbine, so that the front end of the turbine rotor assembly 10 is pointed into the wind. The wind direction is indicated by an arrow 16. This is called a push-type wind turbine. Push-type wind turbines can also have no rudder but with other rotor assembly orientation control devices. There are also pull-type wind turbines where the rotor assembly is at the down-wind side of the tower, and often has no rudder. The current invention is suitable for both push-type and pull-type wind turbine applications.

The wind turbine rotor assembly 10 includes a number of blades 13 that are mounted on the turbine hub 12. The rotor assembly is free to rotate (19b) around the turbine axis 14 to drive an electrical power generator not shown in the drawings. The blades 13 extend in radial direction from the turbine hub 12, and the blade can be rotated (19c) about its own lengthwise axis and change the pitch angle of the blade.

The invented pitch control apparatus 17 connects each blade 13 to the hub 12, to change and control the pitch angle 33 (19c) of the blade.

FIG. 2 and FIG. 3 depict the invented method 30 and apparatus 17. FIG. 2 shows the shaft 21 is at the left most position and the blade pitch is at the base-rpm angle 32, FIG. 3 shows that the shaft 21 is at the right most position, and the blade pitch is at the maximum angle 33 allowed by the apparatus.

The method 30: The turbine rotor tips tangential velocity 31 is usually perpendicular to the wind direction 16. At base-rpm, the blade airfoils are set at the designed angle of attack 32 with respect to the tangential velocity, which is defined as the base-rpm pitch angle at 0 degree. The blade pitch angle 33 is adjustable from 0 degree to 90 degrees by the invented method, using the excessive centrifugal force Fc of the blade assembly 18 (18 includes the blade 13 and the attached parts of the apparatus 17), plus/minus the weight Wt of the blade assembly 18, and minus the spring 25 pre-load of this invention.

The apparatus 17: Inside the cylindrical housing 22, an internal annular sleeve 23 and a bushing 24 are fixed to ensure the inter-meshed axial and twisting movements of the helical sliding spline shaft 21. The helical angle may be 30 to 45 degrees, and can be either right-handed or left-handed depending on actual application. A coil spring 25 and its lock-nut 26 are attached at the back-end of the spline shaft. Retainer plate 28a is fit at right end, and a grease and dust/mist covers 28b is fit at the left end of the housing. The grease camber 27 is partially filled with grease (grease leaks to the spring chamber is allowed). The housing can be attached to the turbine hub/blade by the screws on the flange 29, and the flange 29 is welded to the housing 22 by web 20. The housing 22 can also be attached top the hub/blade by using the front end screw of the shaft 21. The apparatus 17 works either the front end or the back end is attached to the blade 13, as long as it is installed between the hub 12 and a blade 13.

When the wind speed is lower than or equal to the designed speed for base-rpm, the pitch angle 33 is maintained at zero degree by the pre-loaded spring 25 in the apparatus 17, but the blade is actually set at the designed angle of attack for optimal performance at the designed wind speed (base-rpm), as is in a fixed blade wind turbine. When the wind is stronger than the designed wind speed, centrifugal force Fc of the blade assembly 18 will overcome the spring force to move the spline shaft 21 outward, thus causing the pitch angle 33 to increase. With increasing speed, the outward movement as well as the pitch angle will increase with the (rpm)² of the turbine rotor, until it reaches the full-feathered position (normally at pitch angle <90 degrees), where the wind created torque of turbine rotor is zero, the rotor will slow down gradually. In suddenly increased wind (gust) speed, the blade pitch may over shoot due to rotation inertia of the turbine rotor, the pitch angle 33 can pass the full-feathered position, then the turbine rotor torque will be negative (reversed thrust) to slow down. Therefore, the turbine rotor speed will drop back, the pitch angle 33 and the rotor rpm will stay automatically at some values according to the averaged steady wind speed, and the rotor rpm can never go too high.

In short, when the wind speed is below the designed speed (for base-rpm), the wind turbine operates in its conventional manner. When that base-rpm wind speed is exceeded, the invented apparatus 17 will automatically kick-in to control the rotor rpm and thus minimize the wind force experienced by the wind turbine rotor. In the mean time the rotor torque is normally increased with wind speed due to the increased pitch, therefore the power generated is often increased.

The ripple vibrations of the blade axial movement and pitch changing are damped-out by the grease in the grease chamber 27 of the invented apparatus 17. The grease also lubricates the spline and sleeve 23, bushing 24, and spring 25, also rust-proofing the components to achieve free-maintenance of the invented apparatus 17.

No extra power sources or control-electronics are needed for the invented method 30 and apparatus 17. No external command or artificial control is needed. The wind turbine blade pitch control works in a fully automatic fashion.

It is apparent that the present invention (method 30) decreases the excessive stresses caused by rotational over-speed due to excessive wind speed and thus protects the wind turbine from destruction. Also, the invented apparatus 17 can fit to any existing fixed-pitch horizontal wind turbine blades to change it to an adjustable pitch machine, to assure high wind protection, improve its performance and its power generation.

What is claimed is:

1. A method for adjusting the pitch angle of the blades in a horizontal axis windmill having a rotating hub capable of rotating 360 degrees about the horizontal axis, said windmill also having at least one blade radially connected to the hub, where the wind flow exerts force on said blade to rotate said hub and to generate power via the wind mill system, the method comprising:
allowing said blade to move outwardly away from said hub in an axial direction along the blade axis, when the centrifugal force exerted upon said blade due to the rotation of said hub exceeds a predetermined rotational speed;
converting the outward axial movement of said blade to pitch angle movement of said blade.

2. The method of claim 1, wherein the step of converting the outward axial movement of said blade to pitch angle movement of said blade occurs mechanically without the use of external power.

3. The method of claim 1, wherein the step of converting the outward axial movement of said blade to pitch angle movement of said blade further comprises:
linearly adjusting the pitch angle of said blade within a predetermined range in relation to the distance from said blade to said hub.

4. The windmill pitch control apparatus comprising:
a coupling means for connecting one or more blades to a hub;
said coupling means allowing said blade to move axially outward and inward;
said coupling means also adjusting the pitch angle of said blade based upon the distance said blade has moved axially away from the hub; and
a retainer inside the coupling means having one distal end attached to the hub, and the other distal end of said apparatus attached to said blade.

5. The windmill pitch control apparatus of claim 4, wherein said retainer holds said blade at the position closest to said hub unless the centrifugal force exerted upon said blade assembly due to the rotation of said hub exceeds a predetermined rotational speed.

6. The windmill pitch control apparatus of claim 5, wherein said blade's pitch angle at the position closest to said hub is a predetermined optimum pitch angle.

7. The windmill pitch control apparatus of claim 6, wherein said blade's pitch angle at the position farthest from said hub is orthogonal to said predetermined optimal pitch angle.

8. The windmill pitch control apparatus of claim 5, wherein said coupling means comprises:
a cylinder with internal fixed annular sleeve connected to said hub, said fixed annular sleeve having grooves that convert axial movement of the spline shaft into rotation along the axis of said blade;
a helical spline shaft connected to said blade, said helical spline shaft having spline teeth capable of mechanically intermeshing with said fixed annular sleeve through said spline grooves, such that axial movement of the helical spline shaft results in rotation of the shaft, thus the movement of said blade's pitch angle.

9. The windmill pitch control apparatus of claim 7, wherein said retainer comprises:
a coil spring surrounding said helical spline shaft;
a lock nut pre-loading the spring to balance the centrifugal forces exerted by said blade and said helical spline shaft at a predetermined angular velocity of the wind turbine.

10. The windmill pitch control apparatus of claim 8, wherein said coupling means comprises:
a cylinder with internal fixed annular sleeve connected to said blade;
said fixed annular sleeve having grooves that convert axial movement into rotation along the axis of said blade;
a helical spline shaft connected to said hub, said helical spline shaft having spline teeth capable of mechanically interfacing with said fixed annular sleeve through said grooves, such that axial movement of said cylinder with internal fixed annular sleeve results in rotation of said blade's pitch.

11. The windmill pitch control apparatus of claim 8, wherein said coupling means comprises:
a cylindrical cam shaft connected to said hub;
a cylinder with internal cam follower connected to said blade;
wherein said cam follower is capable of mechanically interfacing with said cylindrical cam such that axial movement of said cam follower results in rotation of said blade's pitch.

12. The windmill pitch control apparatus of claim 8, wherein said coupling means comprises:
a cylindrical cam shaft connected to said blade;
a cylinder with internal cam follower connected to said hub;
wherein said cam follower is capable of mechanically interfacing with said cylindrical cam such that axial movement of said cylindrical cam results in rotation of said blade's pitch.
